(19) United States
(12) Patent Application Publication
(10) Pub. No.: US 2024/0378901 A1
(43) Pub. Date: Nov. 14, 2024

(54) CARGO-SPACE MANAGEMENT SYSTEM, VEHICLE AND METHOD FOR LOADING AND UNLOADING OBJECTS

(71) Applicant: Ford Global Technologies, LLC, Dearborn, MI (US)

(72) Inventors: Abhinav Dhake, Meerbusch (DE); Mark Gijbels, Vlaams-brabant (BE); Alexander Katriniok, Aachen (DE)

(73) Assignee: Ford Global Technologies, LLC, Dearborn, MI (US)

(21) Appl. No.: 18/655,772

(22) Filed: May 6, 2024

(30) Foreign Application Priority Data
May 8, 2023 (DE) 102023111948.6

(51) Int. Cl. G06V 20/59; B60R 11/00; B60R 11/04; B65G 1/02

(52) U.S. Cl. CPC G06V 20/59; B60R 11/04; B65G 1/02; B60R 2011/0036

(57) ABSTRACT

The present disclosure relates to a cargo-space management system (10) for a cargo space (14), to a vehicle (12) and to methods for loading and unloading objects. The cargo-space management system (10) comprises at least one camera system (16), a control device (24) having an object identification mechanism and a locating mechanism, and at least one human-machine interface (30). The control device (24) is coupled at least to the camera system (16) and the human-machine interface (30). At least one camera (18) of the camera system (16) has a mounting device (20) such that the respective camera (18) can be positioned in a displaceable manner within the cargo space (14).

### CROSS-REFERENCE TO RELATED APPLICATIONS

The present application claims priority to and the benefit of German Application No. 102023111948.6, filed on May 8, 2023, which is hereby incorporated by reference herein in its entirety.

### FIELD

The present disclosure relates to a cargo-space management system for a cargo space, to a vehicle and to methods for loading and unloading objects.

### BACKGROUND

Drivers of commercial vehicles, in particular delivery vehicles, have various tasks that they have to perform repeatedly. For example, drivers of delivery vehicles have to load parcels into the cargo space, re-sort these parcels several times a day, identify the correct parcel for the next delivery location and remove it from the cargo space. As these repetitive steps have hitherto been performed substantially manually, they cause inefficiencies in the logistics chain, which is unwantedly time-consuming and unproductive.

Known from US 2021/0319582 A1, GB 2553039 A, JP 2020142891 A and U.S. Pat. No. 10,148,918 B1 are semi-automated cargo space management systems that are based on the acquisition of image data by means of rigidly mounted cameras. Because of this, the cargo space is scanned only to an insufficient extent, or a large number of cameras are required, making the corresponding systems complex and involving a large amount of work. There is therefore a need to eliminate, or at least reduce, the disadvantages of known systems. In particular, there is a need to create a cargo-space management system that has fewer individual components than known systems and by means of which it is possible to reduce the amount of work involved.

### SUMMARY

The object is achieved by the provisions of the independent claims. Advantageous designs are given in the dependent claims and the following description, each of which may individually or in (sub) combination represent aspects of the disclosure. Individual aspects are explained with regard to devices, others with regard to methods. However, the aspects are mutually applicable as appropriate.

According to one aspect, a cargo-space management system for a cargo space is provided. The cargo-space management system comprises at least one camera system, a control device having an object identification mechanism and a locating mechanism, and at least one human-machine interface.

The camera system has at least a plurality of cameras. At least one of the cameras is configured to acquire depth information of an object within the cargo space.

The control device is coupled at least to the camera system and the human-machine interface.

The object identification mechanism of the control device is configured to determine an identity of objects within the cargo space, on the basis of at least one object property.

The locating mechanism of the control device is configured to determine a position of an object within the cargo space.

The control device is configured to determine an object identifier of a specific object, and to output the object identifier to the human-machine interface. The object identifier includes at least the identity and the position of the specific object.

At least one camera of the camera system has a mounting device such that the respective camera can be positioned in a displaceable manner within the cargo space.

There is thus created a cargo-space management system that is configured, on the one hand, to reliably determine the identity of objects and their position within the cargo space and, on the other hand, to provide for a user (e.g. a delivery vehicle driver), at the human-machine interface, items of information about the objects or a specific object. This significantly increases convenience for the driver, who then does not have to manually identify objects or independently ascertain their position. This also increases the operational efficiency of loading or unloading processes and the use of the cargo space as a whole.

In contrast to known systems, the complexity of the present cargo-space management system is also reduced. In the prior art, rigidly mounted cameras are used, which means that the underlying systems require a multiplicity of different cameras in order to adequately cover the cargo space. In the present case, the number of cameras required can advantageously be reduced. Since at least one camera can be positioned displaceably, the action space of at least this camera is enlarged. This eliminates the need for a multiplicity of different cameras to adequately cover the cargo space. Fewer individual components are therefore required. This reduces the amount of work involved and increases the efficiency of the cargo-space management system.

Preferably, the cameras of the camera system may have differing properties. For example, a first camera may be configured to acquire RGB data, CYMK data or data from other color tables, i.e. image data based on differing contrasts, colorings or brightness differences. On the other hand, at least one camera is configured to acquire depth information. This means that the camera is configured to represent, in the output image data or corresponding data, the distance of an object from the camera. The image data acquired in each case are transmitted from the cameras of the camera system to the control device.

A cargo space in the present case may be understood to be any suitable volume, preferably a closed volume that is suitable for receiving and storing objects. For example, the cargo space may be a cargo space (or storage space) of a delivery vehicle. Alternatively, the cargo space may also be a storage volume in a building or a higher-level object, for example a transport container. Other designs of the cargo space are also conceivable.

Objects in the present case may be understood to mean, in particular, packages, items of cargo or other items arranged in the cargo space.

The object identification mechanism of the control device identifies objects within the cargo space on the basis of at least one property of the respective object. For this, the object identification mechanism uses image data provided by the camera system. For this purpose, either image data provided by the camera that may also acquire depth information, or image data provided by other types of cameras, may be used.

For example, the object identification mechanism may determine the identity of an object on the basis of the external dimensions of the object. Alternatively, the identity may also be identified on the basis of, for example, a barcode or similar serial mark such as, for example, a company logo or other imprint arranged on the outer surface of the object. Other properties that may be used to identify an object are the shape, colour or other geometric features that characterize the object.

The locating mechanism of the control device determines a position of an object within the cargo space with respect to a relative coordinate system of the cargo space. For this purpose, the locating mechanism uses at least image data from the camera system. In particular, at least image data from the camera configured to acquire depth information are used. In this way, the position of an object may be determined not only two-dimensionally, but actually three-dimensionally within the cargo space.

Alternatively or cumulatively, the locating mechanism of the control device determines a position of an object within the cargo space relative to other objects within the cargo space. This means that, instead of or in addition to an absolute position of an object within the cargo space (in relation to a coordinate system of the cargo space), a relative position of an object relative to other objects may be determined. Here, when reference is made to the position of an object, this position may include both absolute and relative coordinates of the object.

Optionally, the cargo-space management system has at least one rail device on which at least one camera can be mounted in a displaceable manner. The rail device advantageously defines a specific trajectory along which the camera is displaceable. This simplifies the analysis of the image data acquired by means of the camera mounted on it.

In some embodiments, the rail device may have a rectilinear trajectory. This coordinate system, determined by the rail device, is thus made particularly simple. Alternatively, the rail device may also have a curved trajectory, for example in order to be optimally adapted to the volume of the cargo space.

Preferably, the at least one rail device may extend substantially between a first outer wall of the cargo space and a second outer wall of the cargo space that is opposite the first outer wall. The rail device is then configured to ensure that the camera can be displaced at least along a lateral extent of the cargo space.

Preferably, the cargo-space management system has at least one rail device arranged substantially horizontally and one rail device arranged substantially vertically. This enables the cargo space to be scanned in its entirety by means of only two rail devices and one camera mounted on each.

Obviously, more rail devices may also be provided in order to adapt the cargo space management system to the cargo space as required.

Optionally, assigned to a mounting device for a camera there a drive unit, having an electric motor by means of which the camera can be shifted long a rail device. Thus, by means of the electric motor, the camera may thus also be displaced automatically along the rail device. Preferably, the control device is configured to effect closed-loop control of displacement of the camera along the rail device, for example by means of a drive unit assigned to the mounting device of a camera. This makes it possible to displace the camera in an automated manner with respect to the rail device, for example in order to scan different regions of the cargo space.

In some embodiments, the object identification mechanism of the control device has a machine learning algorithm. On the basis of the algorithm, objects can be identified. From the image data of the camera system, the algorithm is able to differentiate between various properties of the objects. These include, in particular, the object properties already explained. The algorithm may accordingly be trained to differentiate and identify objects on the basis of the properties. Training of the algorithm may also be effected during operation. A neural network may be used as the basis for the algorithm within the object identification mechanism of the control device.

Preferably, the object identification mechanism of the control device is configured to be at least partially executable as a cloud server mechanism. The control device can be coupled to a cloud server. This means that the control device has at least one communication device by means of which the control device may communicate with a cloud server. In particular, the underlying algorithm of the object identification mechanism may be executable on the cloud server. The control device then transmits the corresponding image data from the camera system to the cloud server, where they are analyzed in order to identify specific objects within the cargo space. This makes it possible to provide the object identification mechanism with data, from different control devices, that have been acquired in relation to different cargo space management systems. As the amount of data made available to the object identification mechanism is thus considerably increased, the decision-making processes on which the object identification mechanism is based are refined. In particular, the algorithm may be further trained with machine learning during operation, thereby increasing the confidence of the individual identification of an object.

Optionally, the locating mechanism of the control device is configured to divide the cargo space into sections, and to identify in which specific section an object is positioned. The control device is configured to assign the specific section to the object identifier. This allows an intuitive subdivision of the cargo space, which may be used to communicate the position of an object within the cargo space in a self-explanatory manner. This makes it easier for the driver to find a particular object within the cargo space, thereby increasing operational efficiency.

Optionally, the sections may relate to regions of a shelving system, for example shelving compartments, arranged in the cargo space. The individual sections may also have identifiers such as, for example, numbers that can be assigned to the object identifier. The object identifier, including the respective identifier of the section for a specific object, may then be output by means of the human-machine interface.

Preferably, at least one mounting device is realized in such a way that a camera positioned by means of it can be swiveled. This further increases the variability of the arrangement of the cameras, as a result of which the cargo space may be scanned even more efficiently by cameras. A drive unit that is assigned to a mounting device may also be configured to pivot a camera with respect to the mounting device.

In some embodiments, the locating mechanism of the control device is additionally configured to generate a virtual spatial model of the cargo space, which can be output via the human-machine interface, in particular initiated by the control device. This enables the driver to locate an object within the cargo space even more intuitively on the basis of the spatial model.

Alternatively, the virtual spatial model of the cargo space may also be predetermined. The model may then be stored within the locating mechanism or used by it. For example, different vehicles may have similar cargo spaces. In this case, of course, it is necessary to create only one virtual spatial model of the cargo space, which is made known to the respective control devices, or to the locating mechanism thereof. For example, the model may be stored on a memory device coupled to the control device, or on a cloud server.

Alternatively, the camera system may also be used to first create a virtual model of the cargo space, in order then to determine the position of an object relative to the virtual model. The spatial model may then be made available for the locating mechanism.

Preferably, the human-machine interface comprises at least one of an indicator lamp, a laser pointer, a display screen or AR glasses (augmented reality glasses).

The indicator lamps may be arranged, for example, within the cargo space and, optionally, assigned to different regions such as, for example, sections of the cargo space. If the driver wishes to identify a particular object at a loading location, its position may be represented, for example, simply by activation of the corresponding indicator lamp.

In one alternative, a movable laser pointer, for example, may be used, which is influenced by the control device in such a way that it shines on an object to be identified, if this is selected by the driver.

The display screen may show, for example, a virtual spatial model of the cargo space, within which the object is highlighted so that the driver can easily find it.

A virtual spatial model may also be used in a corresponding manner if AR glasses are used. The control device preferably has at least one data processing device.

Optionally, the control device preferably comprises at least one communication interface, to enable communication with a server or other devices.

Preferably, there is at least one memory device assigned to the control device.

The cargo-space management system provides multiple application possibilities. For example, the cargo-space management system may be used during loading or unloading of the cargo space.

According to a further aspect, there is also provided a method for loading objects into a cargo space by means of the cargo-space management system as previously described. The method comprises at least the following steps:

A specific object is positioned in a cargo space.

An identity and a position of the specific object are determined on the basis of the object identification mechanism and the locating mechanism of the control device.

An object identifier of the specific object is determined by the control device. The object identifier includes at least the determined identity and the determined position of the specific object.

The object identifier is output at the human-machine interface.Or:

The object identifier is stored in a memory device assigned to the control device. Or:

The object identifier is output at a communication interface of the control device.

According to an additional aspect, there is also provided a method for unloading objects from a cargo space by means of the cargo-space management system as previously described. The method comprises the following steps:

A notification regarding a specific object to be unloaded, and an object identifier thereof, is received by the control device.

The cargo space is scanned by the camera system with respect to a specified position, determined by the object identifier, of the specific object to be unloaded.

The object identifier is output by the control device via the human-machine interface if the specific object to be unloaded is identified at the specified position on the basis of the object identification mechanism and the locating mechanism of the control device. Or:

The entire cargo space is scanned until the specific object to be unloaded is identified at another current position on the basis of the object identification mechanism and the locating mechanism of the control device. An updated object identifier is then output by the control device via the human-machine interface. The updated object identifier includes the current position of the specific object to be unloaded. Or:

An error message is output.

In the loading process, the cargo-space management system may assist in the automated creation of data sets of object identifiers that indicate which specific object is located at which specific position within the cargo space. The object identifier may then be output at the human-machine interface.

Alternatively or cumulatively, the object identifier may also be used to build a database, which may be stored, for example, in a memory device assigned to the control device.

Alternatively or cumulatively, the object identifier determined in this way may also be provided by the control device, by means of a communication interface of the control device, for further devices or applications. For example, the object identifier determined in this way may then be used by a delivery application.

During further use, the object identifier may then be used as required in order to achieve advantageous effects also in the unloading of the cargo space, in particular to enable unloading within a shorter period of time.

For this purpose, the control device receives a notification as to which specific object is to be unloaded at a particular loading location. In principle, the control device in this case needs to be informed only of the identity of the object, but not its specified position. Once the identity of the specific object is known to the control device, the latter can then search through known object identifiers for the specific object, for example within a database.

Alternatively, the notification to the control device may also include the specified position of the object to be unloaded.

As soon as the object identifier of the object to be unloaded has been found in the database by the control device, the control device basically knows at which position of the cargo space the object should be located (specified position). This is then checked by the cargo-space management system by means of the locating mechanism and the object identification mechanism.

If the object cannot be found at the specified position, the cargo-space management system is used to search through the entire cargo space for the specific object. Both the object identification mechanism and the locating mechanism of the control device are used for this purpose. If the specific object is identified and found at a different position within the cargo space, an updated object identifier is determined. The updated object identifier includes the actual position of the specific object. The updated object identifier may then be output by the control device. This makes it possible to detect a change in the position of an object compared to a position specified in the original object identifier, and to update the object identifier accordingly.

If the object cannot be found either at the position of the original object identifier or elsewhere in the cargo space, an error message is output to inform the user that the object cannot be found.

The basis for the methods is the load management system as described above, which makes it possible to improve operational efficiency in both the loading and the unloading of the cargo space.

The methods may be further developed through various optional steps.

For example, the objects may be scanned in advance before the cargo space is loaded, for example in a distribution center, in order to determine the identity of a respective object. In this case, object identifiers may already be determined as described above. Optionally, the machine learning algorithm, for example, may also be used to evaluate the identity of the objects. In this respect, object identifiers comprising at least one identity of the respective object may already be created before the cargo space is loaded. These object identifiers may be made available to the control device, for example via a communication interface thereof.

Optionally, the camera system may also be used before the cargo space is loaded in order to scan the cargo space. A coordinate system may then be determined, for example, which accordingly describes the positions within the cargo space. Alternatively, for example a virtual spatial model of the cargo space may be created. Both the coordinate system and the model may also be made known to the control device.

Obviously, the method for loading objects may also be further developed in such a way that a plurality of objects are processed according to the method. Then at least the step of scanning and identifying a positioned object within the cargo space is performed repeatedly on the basis of the cargo space management system. Accordingly, the particular object identifiers are output.

According to a further aspect, a vehicle having a cargo space and a cargo-space management system as described above is also provided.

Here, a vehicle is understood to be a device configured to transport items, cargo or people between different destinations. Examples of vehicles include land-based vehicles such as motor vehicles, electric vehicles, hybrid vehicles or the like, rail vehicles, aircraft or watercraft. Preferably, vehicles in the present context may be considered to be road-based vehicles such as, for example, cars, trucks, buses or the like.

All of the features explained with regard to the various aspects can be combined individually or in (sub) combination with other aspects.

### BRIEF DESCRIPTION OF THE DRAWINGS

The disclosure and further advantageously embodiments and developments thereof are described and explained more fully below with reference to the examples represented in the drawings, in which:

FIG. 1 shows a simplified schematic representation of a vehicle having a cargo-space management system, according to one embodiment,

FIG. 2 shows a simplified schematic representation of a method for loading objects in a vehicle, according to one embodiment, and

FIG. 3 shows a simplified schematic representation of a method for unloading objects from a vehicle, according to one embodiment.

### DETAILED DESCRIPTION

The following detailed description in conjunction with the accompanying drawings, in which elements that are the same are denoted by the same numbers, is intended as a description of various embodiments of the disclosed subject-matter, and is not intended to represent the only embodiments. Any embodiment described in this disclosure is by way of example or illustration only, and should not be construed as being preferred or advantageous over other embodiments. The illustrative examples contained herein are not intended to be exhaustive and do not limit the claimed subject-matter to the exact forms disclosed. Various modifications of the described embodiments will be readily apparent to a person skilled in the art, and the general principles defined herein may be applied to other embodiments and applications without departure from the spirit and scope of the described embodiments. The embodiments described are therefore not limited to the embodiments shown, but have the widest possible scope of application consistent with the principles and features disclosed herein.

Any of the features disclosed below with respect to the exemplary embodiments and/or the accompanying figures may be combined alone or in any sub-combination with features of the aspects of the present disclosure, including features of preferred embodiments, provided that the resulting combination of features is meaningful to a person skilled in the art.

For the purposes of the present disclosure, the expression “at least one of A, B and C” means, for example, (A), (B), (C), (A and B), (A and C), (B and C) or (A, B and C), including all other possible combinations when more than three elements are listed. In other words, the term “at least one of A and B” means in general “A and/or B”, namely “A” alone, “B” alone or “A and B”.

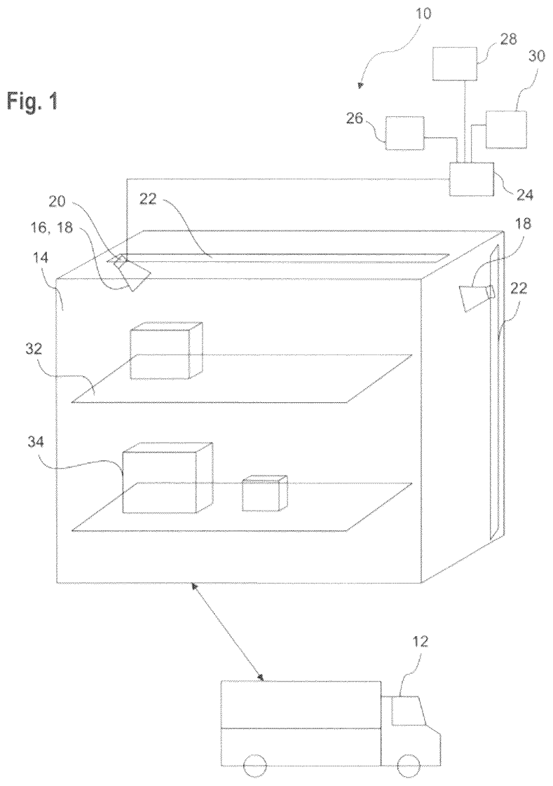

FIG. 1 shows a simplified schematic representation of a vehicle 12 having a cargo-space management system 10, according to one embodiment.

The cargo-space management system 10 is arranged within the cargo space 14 of the vehicle 12.

A camera system 16 comprises a plurality of cameras 18, of which, in this case, all cameras 18 can be positioned in a displaceable manner. For this purpose, the cameras 18 have mounting devices 20 by means of which they can be displaced along various rail devices 22.

The cargo-space management system 10 additionally comprises a control device 24, which has at least one data processing device. The control device 24 additionally comprises the object identification mechanism and the locating mechanism.

The control device 24 is coupled to the cameras 18 of the camera system 16.

The control device 24 also comprises a communication device. By means of the communication device, the control device 24 is coupled to a cloud server 28. Parts of the object identification mechanism and of the locating mechanism, for example a machine learning algorithm, may be stored remotely from the control device 24, for example within the cloud server 28.

In addition, the control device 24 is coupled to a human-machine interface 30. According to this embodiment, the cargo space 14 comprises a shelving system 32 by means of which different objects 34 are positioned within the cargo space 14.

The cameras 18 can be positioned, in particular by means of the rail device 22, in such a way that they can scan the entire cargo space 14. For this purpose, a first rail device 22 is arranged horizontally, and a second rail device 22 is arranged vertically.

At least one camera 18 of the camera system 16 is configured to acquire depth information within the cargo space 14, i.e. a distance of an object 34 from the camera 18.

The image data acquired by the cameras 18 are transmitted to the control device 24. Within the control device 24, or with the aid of external devices such as, for example, the cloud server 28 or the memory device 26, the control device 24 is configured to implement the object identification mechanism and the locating mechanism.

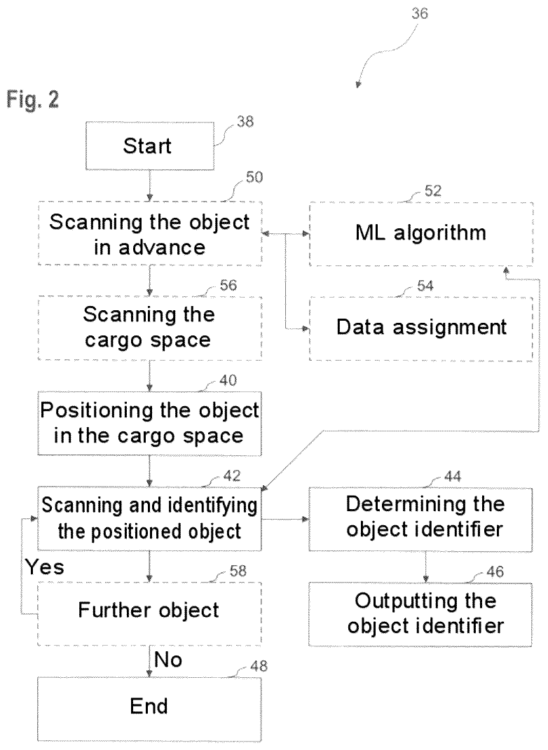

FIG. 2 shows a simplified schematic representation of a method 36 for loading objects in a vehicle 12, according to one embodiment. Optional steps are represented by dashed lines. Optional steps may be part of the method 36 individually or in combination.

Following the start 38, in the step 40 an object 34 is positioned within the cargo space 14.

In the step 42, the object 34 is identified by the control device 24 on the basis of data acquired by the camera system 16 based on the object identification mechanism and the locating mechanism, and its position is ascertained.

Then, in the step 44, an object identifier of the object 34 is determined by the control device 24. The object identifier includes both the identity of the object 34 and its position.

In the step 46, the thus determined identifier is output by the control device 24. For example, the object identifier may be output at a human-machine interface 30. Alternatively or cumulatively, the object identifier may also be stored in the memory device 26 assigned to the control device 24. In this way, a database containing determined object identifiers may be created or updated. Alternatively or cumulatively, the determined object identifier may also be provided by the control device 24, by means of a communication device, for other devices or applications, for example a delivery application. The delivery application may then, for example, define a travel route for the vehicle 12 to enable the objects 34 to be transported as efficiently as possible to unloading locations.

Finally, the method 36 ends at step 48.

Optionally, objects 34 may also be scanned in advance, in the step 50. This means that an identity of an object 34 may already be determined in the step 50, for example outside of the cargo-space management system 10. For example, the scanning of the objects 34 in advance may be effected in a distribution center. Since the machine learning algorithm may also be stored in the cloud server 28, the algorithm may also be used in the scanning in advance in the step 52. The scanning in advance may correspond to the functionality of the object identification mechanism, but not performed by the control device 24.

As a result, object identifiers may already be determined in the optional step 54. The object identifiers in this case are determined in the same way as described above. The object identifiers of the optional step 54 include at least the identity of the objects 34, but not a position of the object 34. The thus determined object identifiers may already be transmitted to the control device 24 before the vehicle 12 is loaded. It may thus be checked, for example, whether the object identifiers determined by the control device 24 match, with respect to the identity of the actually loaded objects 34, the object identifiers transmitted to the control device 24 by an external device prior to loading the vehicle 12. In other words, it may be ascertained whether the intended objects 34 are actually loaded into the vehicle 12.

In the optional step 56, the cargo space 14 of the vehicle 12 may be scanned. As a result, for example a virtual spatial model of the cargo space 14 may be created. The cargo space 14 may also be divided into sections, which are taken into account by the control device 24 in the assessment of the object identifiers of the objects 34.

In the optional step 58, a query is effected as to whether further objects 34 have been loaded into the cargo space 14. If this is the case, steps 42, 44, 46 are repeated accordingly for each further object 34.

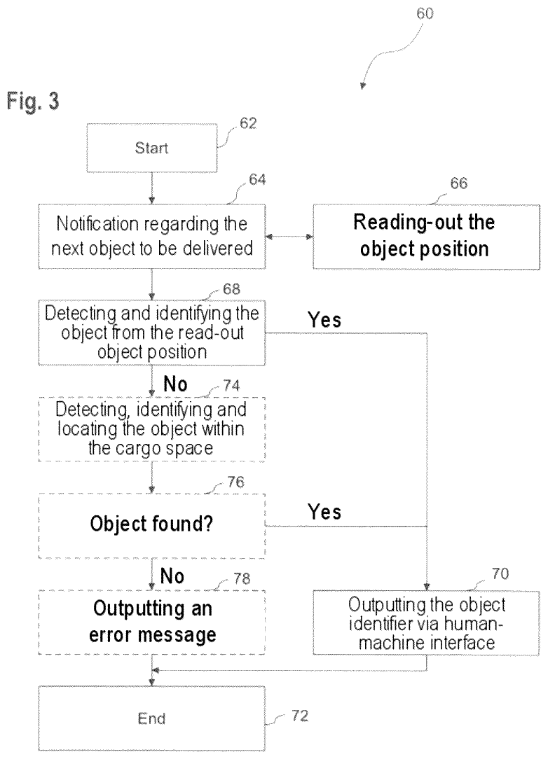

FIG. 3 shows a simplified schematic representation of a method 60 for unloading objects from a vehicle 12, according to one embodiment. Optional steps are represented by dashed lines. Optional steps may be part of the method 60 individually or in combination.

Following the start 62, according to this embodiment the control device 24 receives, in the step 64, a notification regarding the next object 34 to be unloaded. In particular, the notification includes the identity of the object 34 to be unloaded.

Then, in the step 66, the control device 24 reads out a specified position of the object 34 to be unloaded. The specified position corresponds to the last ascertained position of the object 34. For this purpose, the control device 24 in this case searches the memory device 26 for the object identifier having the identity that corresponds to the identity of the object 34 to be unloaded.

Alternatively or cumulatively, the memory device 26 may also communicate with the cloud server 28, in which the object identifiers from a previously effected method 36 for object loading may be stored.

Alternatively or cumulatively, the notification in the step 64 may also include the corresponding object identifier, including the specified position of the object 34 to be unloaded. In this case, the memory device 26 reads out from the object identifier only the position of the respective object 34 specified therein.

In the step 68, the cargo space 14 is scanned by the camera system 16 with regard to the specified position of the object 34 to be unloaded. The control device 24 uses the object identification mechanism and the locating mechanism to check whether the object 34 to be unloaded can be identified and located at the specified position that has been read out.

If this is the case, the corresponding object identifier is output by the control device 24 via the human-machine interface 30 in the step 70.

The method 60 then ends in the step 72.

Optionally, the method 60 may be developed in such a way that, if the object 34 to be unloaded cannot be identified or located at the specified position, the entire cargo space 14 is scanned in the step 74. The control device 24 ascertains the positions and identities of all objects 34 arranged in the cargo space 14, until the object 34 to be unloaded is located.

If it is ascertained in the step 76 that the object 34 to be unloaded has been located, the step 70 is affected.

If it is ascertained in the step 76 that the object 34 to be unloaded cannot be located within the entire cargo space 14, an error message is output by the control device 24 in the optional step 78. Optionally, the error message in this case may be output by the control device 24 via the human-machine interface 30.

The cargo-space management system 10 thereby enables efficiency to be increased in the loading and also unloading of a vehicle 12 with objects 34.

Certain embodiments disclosed herein, in particular the control device 24, the camera system 16, the cloud server 28, and the human-machine interface 30 use circuits (for example, one or more circuits) to implement standards, protocols, methods, or technologies disclosed herein, to operably couple two or more components, generate items of information, process items of information, analyze items of information, generate signals, encode/decode signals, convert signals, transmit and/or receive signals, control other devices, etc. Circuits of any type may be used.

In one embodiment, a circuitry such as the control device 24 comprises, inter alia, one or more data processing devices, such as a processor (for example, a microprocessor), a central processing unit (CPU), a digital signal processor (DSP), an application-specific integrated circuit (ASIC), a field-programmable gate array (FPGA), a system on a chip (SoC), or the like, or any combinations thereof, and may comprise discrete digital or analogue circuit elements or electronics, or combinations thereof. In one embodiment, the circuit comprises hardware circuit implementations (for example, analogue circuitry implementations, digital circuitry implementations, and the like, and combinations thereof).

In one embodiment, circuits comprise combinations of circuits and computer program products with software or firmware instructions stored on one or more computer-readable memories that act in combination to cause a device to execute one or more of the protocols, methods, or technologies described herein. In one embodiment, the circuitry comprises circuits such as, for example, microprocessors or portions of microprocessors, that require software, firmware, and the like to operate. In one embodiment, the circuits comprise one or more processors or portions thereof and the associated software, firmware, hardware and the like.

In the present application, reference may be made to quantities and numbers. Unless expressly stated, such quantities and numbers are not to be regarded as limiting, but as examples of the possible quantities or numbers in the context of the present application. In this context, the term “plurality” may also be used in the present application to refer to a quantity or number. In this context, the term “plurality” means any number greater than one, for example, two, three, four, five, etc. The terms “about”, “approximately”, “near”, etc. mean plus or minus 5% of the stated value.

Although the disclosure has been represented and described with reference to one or more embodiments, a person skilled in the art, after reading and understanding this description and the accompanying drawings, may make equivalent changes and modifications.

1. A cargo-space-management system (10) for a cargo space (14), the cargo-space management system (10) comprising:
at least one camera system (16),
a control device (24) having an object identification mechanism and a locating mechanism, and at least one human-machine interface (30),
the camera system (16) having at least a plurality of cameras (18), and least one of the cameras (18) being configured to acquire depth information of an object (34) within the cargo space (14),
the control device (24) being coupled at least to the camera system (16) and the human-machine interface (30),
the object identification mechanism of the control device (24) being configured to determine an identity of objects (34) within the cargo space (14), on the basis of at least one object property,
the locating mechanism of the control device (24) being configured to determine a position of an object (34) within the cargo space (24),
the control device (24) being configured to determine an object identifier of a specific object (34), and to output the object identifier to the human-machine interface (30), the object identifier including at least the identity and the position of the specific object (34), and at least one camera (18) of the camera system (16) having a mounting device (20) such that the respective camera (18) can be positioned in a displaceable manner within the cargo space (14).

2. The cargo-space management system (10) according to claim 1, wherein the cargo-space management system (10) has at least one rail device (22) on which at least one camera (18) can be mounted in a displaceable manner.

3. The cargo-space management system (10) according to claim 2, wherein the cargo-space management system (10) has at least one rail device (22) arranged substantially horizontally and one rail device (22) arranged substantially vertically.

4. The cargo-space management system (10) according to claim 1, wherein the object identification mechanism of the control device (24) has a machine learning algorithm, identities of objects (34) being able to be determined on the basis of the algorithm.

5. The cargo-space management system (10) according to claim 1, wherein the object identification mechanism of the control device (24) is configured to be at least partially executable as a cloud server mechanism, the control device being able to be coupled to a cloud server (28).

6. The cargo-space management system (10) according to claim 1, wherein the locating mechanism of the control device (24) is configured to divide the cargo space (14) into sections, and to determine in which specific section an object (34) is positioned, and the control device (24) being configured to assign the specific section to the object identifier.

7. The cargo-space management system (10) according to claim 1, wherein at least one mounting device (20) is realized in such a way that a camera (18) positioned by means of it can be swiveled.

8. A vehicle (12) having a cargo-space-management system (10) and a cargo space (14) according to claim 1.

9. A Method for loading objects into a cargo space (14) by means of the cargo-space management system (10) according to claim 1, the method comprising the following steps:
positioning a specific object (34) in the cargo space (14),
determining an identity of the specific object (34) on the basis of the object identification mechanism and a position of the specific object (34) on the basis of the locating mechanism of the control device (24),
determining of an object identifier of the specific object (34) by the control device (24), the object identifier including at least the identify and the position of the specific object (34), and
outputting the object identifier to the human-machine interface (30), or
storing the object identifier in a memory device (26) assigned to the control device (24), or
outputting the object identifier at a communication interface of the control device (24).

10. A method for unloading objects from a cargo space (14) by means of the cargo-space management system (10) according to claim 1, the method comprising the following steps:
receiving, by the control device (24), of a notification regarding a specific object (34) to be unloaded, and an object identifier thereof,
scanning of the cargo space (14) by the camera system (16) with respect to a specified position, determined by the object identifier, of the specific object (34) to be unloaded,
outputting of the object identifier by the control device (24) via the human-machine interface (30) if the specific object (34) to be unloaded is identified at the specified position on the basis of the object identification mechanism of the control device (24), or
scanning the entire cargo space (14) until the specific object (34) to be unloaded is identified at another current position on the basis of the object identification mechanism and the locating mechanism of the control device (24), and outputting of an updated object identifier by the control device (24) via the human-machine interface (30), the updated object identifier including the current position of the specific object (34) to be unloaded, or
outputting an error message.
